(19) United States
(12) Patent Application Publication
(10) Pub. No.: US 2021/0031460 A1
(43) Pub. Date: Feb. 4, 2021

(54) METHODS OF REMOVING SUPPORT STRUCTURES FROM ADDITIVE MANUFACTURED OBJECTS

(71) Applicant: University of Central Florida Research Foundation, Inc., Orlando, FL (US)

(72) Inventors: Fluvio Lobo Fenoglietto, Orlando, FL (US); Robert Sims, Orlando, FL (US); James Joseph Inziello, Orlando, FL (US); Jack Stubbs, Orlando, FL (US)

(21) Appl. No.: 16/946,562

(22) Filed: Jun. 26, 2020

Related U.S. Application Data
(60) Provisional application No. 62/879,914, filed on Jul. 29, 2019.

(51) Int. Cl. B29C 64/40; B29C 64/393; B33Y 10/00; B33Y 50/02; B33Y 40/20

(52) U.S. Cl. CPC B29C 64/40; B29C 64/393; B33Y 40/20; B33Y 50/02; B33Y 10/00

(57) ABSTRACT

A method of selecting, printing, and removing a support removal structure from an additive manufactured object, such that the support removal structure provides structural support for the object during printing. The inclusion of support removal structure within a printed object prevents the object from collapsing during printing. After the printed object is completed and cured during post-processing, the support removal structure is removed from the object to provide an object including accurate physical properties. The support removal structure is elongated and compliant and is specially designed for an individual printed object to provide optimal support during a printing process without tangling during removal.

### CROSS-REFERENCE TO RELATED APPLICATIONS

This nonprovisional application is a continuation of and claims priority to provisional application No. 62/879,914, entitled “Methods of removing support material from additive manufactured objects,” filed on Jul. 29, 2019, by the same inventors.

### BACKGROUND OF THE INVENTION

### 1. Field of the Invention

This invention relates, generally, to support structures in additive manufactured objects. More specifically, it relates to methods of designing, producing, and removing support structures from printed objects.

### 2. Brief Description of the Prior Art

A challenge when manufacturing an additive manufactured (or 3D printed) object is deciding how to provide support for the object. Often, the exterior boundaries of a model can be accurately estimated for printing; however, the interior portions of a printed object do not receive much attention during the printing process. These interior portions can define a cavity disposed within the object, which, if left unfilled, can fail to adequately represent the physical properties of a manufactured object due in part to a lack of support structures disposed within the object. In addition, without adequate support within a printed object during the printing process, portions of the printed object can fail to accurately render, leading to imperfections in or the collapse of the manufactured object.

Attempts have been made to provide support structures for additive manufactured objects. For example, the additions of linkages, hinges, and other linking design features can provide for part folding within a printed object, thereby increasing the structural support of the object. However, such additions increase the amount of material required for a printed object, thereby increasing the costs associated with a printing process. Moreover, the printing time increases as a result of the added material, and post-printing support material optimization and clean-up time similarly increases. Alternative attempted solutions to provide support for a printed object include redesigning a printed object to allow for self-support of the object. However, such a solution is lacking, because it can require modifications of the overall shape and design of an object simply to provide support for the object, which can negatively impact the usefulness of a manufactured object. Removal of support structures and materials has also been attempted by providing a dissolvable support material; however, such a solution includes an associated increased cost due to the requirement of one or more solvents, dissolution time, and drying time of the printed object.

Accordingly, what is needed is a method of accurately printing an object including an amount of a support material that can be easily and efficiently removed post-printing, thereby providing for an accurately-printed object without drastically increasing the costs associated with printing the object. However, in view of the art considered as a whole at the time the present invention was made, it was not obvious to those of ordinary skill in the field of this invention how the shortcomings of the prior art could be overcome.

All referenced publications are incorporated herein by reference in their entirety. Furthermore, where a definition or use of a term in a reference, which is incorporated by reference herein, is inconsistent or contrary to the definition of that term provided herein, the definition of that term provided herein applies and the definition of that term in the reference does not apply.

While certain aspects of conventional technologies have been discussed to facilitate disclosure of the invention, Applicant in no way disclaims these technical aspects, and it is contemplated that the claimed invention may encompass one or more of the conventional technical aspects discussed herein.

The present invention may address one or more of the problems and deficiencies of the prior art discussed above. However, it is contemplated that the invention may prove useful in addressing other problems and deficiencies in a number of technical areas. Therefore, the claimed invention should not necessarily be construed as limited to addressing any of the particular problems or deficiencies discussed herein.

In this specification, where a document, act or item of knowledge is referred to or discussed, this reference or discussion is not an admission that the document, act or item of knowledge or any combination thereof was at the priority date, publicly available, known to the public, part of common general knowledge, or otherwise constitutes prior art under the applicable statutory provisions; or is known to be relevant to an attempt to solve any problem with which this specification is concerned.

### BRIEF SUMMARY OF THE INVENTION

The long-standing but heretofore unfulfilled need for a method of selecting, printing, and removing a support material from an additive manufactured object is now met by a new, useful, and nonobvious invention.

The novel method includes a step of generating a virtual model of an object, such that the virtual model includes a plurality of geometries, including exterior geometries and interior geometries. The exterior geometries define a shape of the object. The interior geometries are disposed opposite the plurality of exterior geometries; in a step, the interior geometries are identified and at least partially defining a cavity disposed within the virtual model. The method includes a step of identifying one or more of the geometries to be supported via a support removal structure during fabrication of the object. In addition, the method includes a step of calculating an amount of a support removal structure to be disposed within the cavity of the virtual model. The support removal structure has an overall shape and dimensions calculated based on the identified plurality of interior geometries. In addition, the support removal structure includes at least two adjoined portions, such that a connection between the adjoined portions is not severed during removal from the structure.

Next, a printed object is manufactured that is based on the virtual model, such that the printed object includes the plurality of exterior geometries, the plurality of interior geometries, the cavity, and the amount of the support removal structure arranged within the cavity in the calculated overall shape and dimensions. An extraction opening is formed within at least one of the plurality of exterior geometries of the printed object, with the extraction opening extending through at least one of the plurality of exterior geometries and at least one of the plurality of interior geometries to provide a channel to the cavity. At least a portion of the amount of the support removal structure, and specifically of each of the at least two adjoined portions, is then removed from the printed object via the extraction opening.

In an embodiment, a space between the support removal structure and the plurality of interior geometries is filled with a support material. The support material is removed via the extraction opening, together with or separate from the support removal structure. In addition, in an embodiment, multiple support removal structures are calculated and manufactured, and at least a portion of each support removal structure is removed via the extraction opening. More than one extraction opening may be formed, and the extraction opening may be formed prior to manufacturing the printed object.

In an embodiment, the step of calculating the amount of the support removal structure includes calculating a path from a first end of the virtual model to a second end of the virtual model. A plurality of linked bodies are propagated about the path. Each subsequent body of the plurality of linked bodies is rotated to join the plurality of linked bodies together, thereby forming the support removal structure. The plurality of linked bodies may be uniform in size and shape, or may be non-uniform in size and shape.

An object of the invention is to provide easily removable support materials disposed within printed or manufactured objects, with the support materials being specially designed via an algorithm to fill the printed object to provide support during printing.

These and other important objects, advantages, and features of the invention will become clear as this disclosure proceeds.

The invention accordingly comprises the features of construction, combination of elements, and arrangement of parts that will be exemplified in the disclosure set forth hereinafter and the scope of the invention will be indicated in the claims.

### BRIEF DESCRIPTION OF THE DRAWINGS

For a fuller understanding of the invention, reference should be made to the following detailed description, taken in connection with the accompanying drawings, in which:

FIG. 1 is a process-flow diagram of a method of selecting, forming, and extracting a support structure from a printed object.

FIG. 2A is an orthogonal top view of a printed object including a plurality of support structures partially disposed therein, in accordance with an embodiment of the present invention.

FIG. 2B is an orthogonal top view of the printed object of FIG. 2A, showing the partial removal of one of the support structures.

FIG. 2C is an orthogonal top view of the printed object of FIG. 2B, showing the removal of one of the support structures.

FIG. 2D is an orthogonal top view of the printed object of FIG. 2C, showing the initial removal of another of the plurality of support structure.

FIG. 2E is an orthogonal top view of the printed object of FIG. 2D, showing the partial removal of the other support structure.

FIG. 2F is an orthogonal top view of the printed object of FIG. 2E, showing the complete removal of the other support structure.

FIG. 3A is an orthogonal top view of a printed object including a weave support structure formed within a printed object, in accordance with an embodiment of the present invention.

FIG. 3B is an orthogonal top view of a printed object including a coiled support structure formed within a printed object, in accordance with an embodiment of the present invention.

FIG. 3C is a close-up orthogonal top view of the coiled support structure of FIG. 3B, including an extraction point through which the coiled support structure is removable from the printed object.

FIG. 4A is a perspective view of a printed object including a partially-extracted support structure, in accordance with an embodiment of the present invention.

FIG. 4B is a perspective view of the printed object of FIG. 4A, including a completely extracted support structure.

FIG. 4C is an orthogonal view of a printed object including an internal support removal structure and an external support removal structure, in accordance with an embodiment of the present invention.

FIG. 5A depicts a support structure generator program rendering of an object including a cavity and an extraction opening, with a small amount of support material disposed within the cavity.

FIG. 5B depicts the rendering of FIG. 5A, including a greater amount of support material.

FIG. 5C depicts the rendering of FIG. 5A, including a greater amount of support material than included in FIG. 5B.

FIG. 5D depicts the rendering of FIG. 5A, including a greater amount of support material than included in FIG. 5C.

FIG. 5E depicts the rendering of FIG. 5A, wherein the cavity is full of the support material.

FIG. 6A depicts a support material generator program rendering of an object including two cavities, an extraction opening, and a break point between the geometries forming the two cavities.

FIG. 6B depicts a bounding box within the program rendering, the bounding box containing the object of FIG. 6A.

FIG. 6C depicts the object of FIG. 6A within the bounding box of FIG. 6B.

FIG. 7A depicts a path created for a virtual model about which a uniform or a non-uniform removable support structure can be generated for printing in an additive manufactured object.

FIG. 7B depicts an embodiment of uniform linking segments generated about the path of FIG. 7A.

FIG. 7C depicts an embodiment of uniform linking segments generated about the path of FIG. 7A.

FIG. 7D depicts an embodiment of non-uniform linking segments generated about the path of FIG. 7A.

### DETAILED DESCRIPTION OF THE INVENTION

In the following detailed description of the preferred embodiments, reference is made to the accompanying drawings, which form a part thereof, and within which are shown by way of illustration specific embodiments by which the invention may be practiced. It is to be understood that other embodiments may be utilized and structural changes may be made without departing from the scope of the invention.

As used in this specification and the appended claims, the singular forms “a,” “an,” and “the” include plural referents unless the content clearly dictates otherwise. As used in this specification and the appended claims, the term “or” is generally employed in its sense including “and/or” unless the context clearly dictates otherwise.

The present invention includes a method of selecting, printing, and removing a support structure from an additive manufactured object. As used herein, “support structure” means any material, body, pattern, whether singular or multiple in nature, including combinations thereof, that is used to support a printed object. The inclusion of support material and a support structure within a printed object is important to provide sufficient support during a printing process, such that the object does not collapse during printing. However, it is desirable to remove the support structure from the object post-printing to provide an object including accurate physical properties. Accordingly, the present invention provides a method of easily and efficiently removing support structures from a printed object, as well as a method of optimizing the amount of support material required during printing.

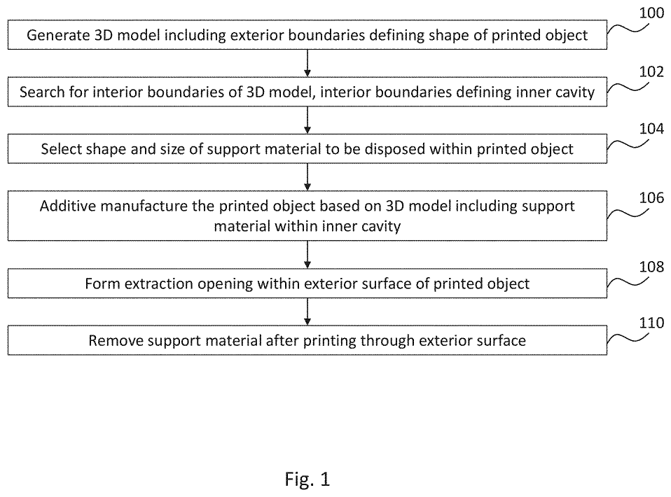

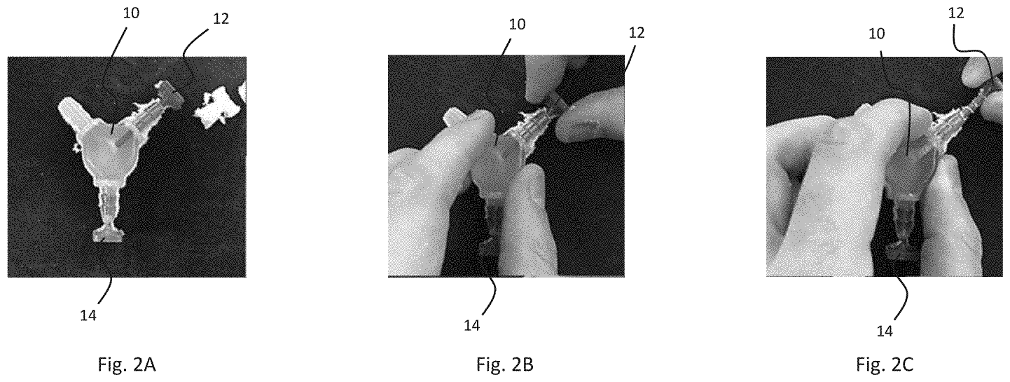

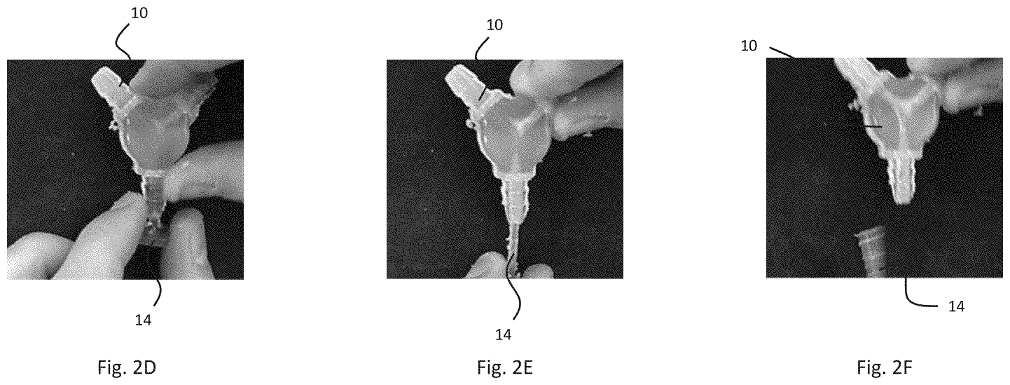

Referring now to FIG. 1, in conjunction with the FIGS. 2A-7D, an exemplary process-flow diagram is provided, depicting an overview of a method of selecting, forming, and extracting a support removal structure from a printed object. The steps delineated in the exemplary process-flow diagram of FIG. 1 are merely exemplary of an order of selecting, forming, and extracting a support removal structure from a printed object. The steps may be carried out in another order, with or without additional steps included therein.

The method of FIG. 1 begins at step 100, during which a three-dimensional, virtual model of an object is generated on an electronic device. The model includes a plurality of exterior geometries, or boundaries, that define the shape of the model and the ultimate shape of a printed object based on the model. As a three-dimensional rendering, the model also includes a plurality of interior geometries, or boundaries, disposed adjacent to the plurality of exterior geometries. The interior geometries of the model at least partially define one or more cavities or one or more channels disposed therein. During step 102, instructions are executed on the electronic device, such as via a software or a plugin, to search for the interior geometries of the model.

During step 104, instructions are executed to select a size and a shape or design of a support removal structure to be disposed within the cavity of the model, such that the support removal structure will be printed with the printed object based on the model. The selection of the size and shape of the support removal structure is made such that the printed object has sufficient support during printing to prevent the collapse of one or more geometries of the printed object. The calculations involved in selecting the size and shape of the support removal structure are discussed in greater detail below.

During step 106, the printed object including one or more lengths of support removal structure is manufactured, such as via an additive manufacturing machine. The printed object is based on the 3D model, as described in greater detail below. During step 108, at least one extraction opening is formed within one of the exterior geometries of the printed object, with the extraction opening providing access therethrough to the cavity and to the one or more lengths of support removal structure. The extraction opening can be automatically present, formed during the printing process (such as by being designed in combination with the 3D model), or can be manually or automatically formed after the manufacture of the printed object. The support removal structure is removed from the printed object via the extraction opening during step 110. If there are multiple lengths and/or diameters of support removal structure, multiple extraction openings may be included in the printed object; during step 110, each of the lengths of support removal structure may be removed from the printed object. The support removal structure includes at least two adjoined portions; during removal, the connection between the adjoined portions is not severed, such that the portions are removable in sequence. In additional optional steps, the cavity within the printed object may be filled with a filler material, and the extraction opening may be covered to form a continuous exterior geometry of the printed object.

In conjunction with the steps in the process-flow diagram of FIG. 1, FIGS. 2A-2F depict an example of printed object 10. Printed object 10 includes a plurality of exterior geometries in mechanical communication with an adjacent plurality of interior geometries, with the plurality of interior geometries defining a cavity disposed within printed object 10. Disposed within the cavity of printed object 10 are first support removal structure 12 and second support removal structure 14, with each of the support removal structures and surrounding support material providing structure to printed object 10 while printed object 10 is being printed. Support material, deposited automatically through the additive process, fills the gaps between support removal structures 12, 14 and the object 10. As such, the plurality of exterior geometries and the plurality of interior geometries of printed object 10 do not collapse into the cavity, thereby destroying the structure of printed object 10. The cavity of printed object 10 may be defined by the entire interior volume of printed object 10, or the cavity may be comprised of one or more channels formed within an interior of printed object 10, depending on the requirements of printed object 10.

FIG. 2A depicts printed object 10 including both first support removal structure 12 and second support removal structure 14, and each subsequent figure in the group of FIGS. 2B-2F depict at least a partial removal of at least one of first support removal structure 12 and second support removal structure 14. The removal of support removal structures causes the removal of support material as well (shown as the white material in FIGS. 2A-F). For example, FIG. 2B depicts a partial removal of first support removal structure 12 from the cavity of printed object 10, while second support removal structure 14 remains disposed within the cavity. Similarly, FIG. 2C depicts a near-complete removal of first support removal structure 12 from the cavity of printed object 10.

As shown in FIG. 2D, the entire length of first support removal structure 12 is removable from printed object 10 via the removal process shown in FIGS. 2A-2C. FIGS. 2D and 2E also depicts the partial removal of second support removal structure 14 from the cavity of printed object 10, with FIG. 2F showing a complete removal of second support removal structure 14 from printed object 10. Importantly, the overall structure of printed object 10, as defined by the plurality of exterior geometries and the plurality of interior geometries, remains intact during the process of removing first and second support removal structures 12, 14 from printed object 10.

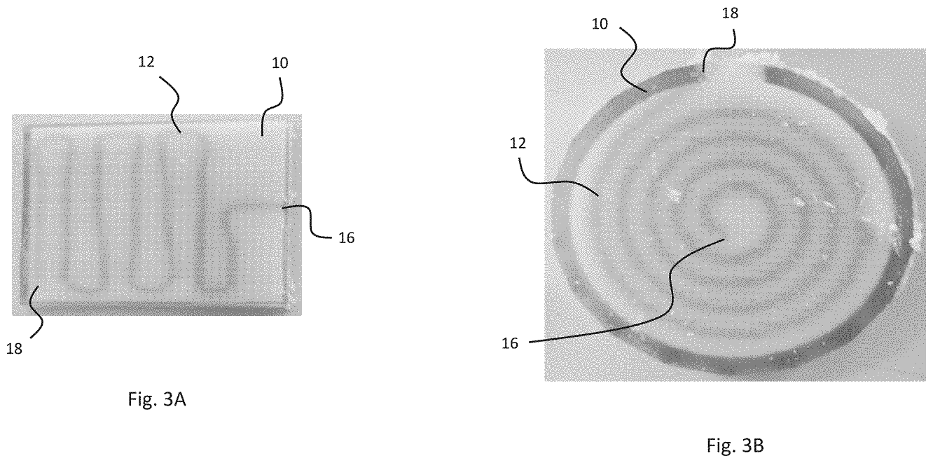

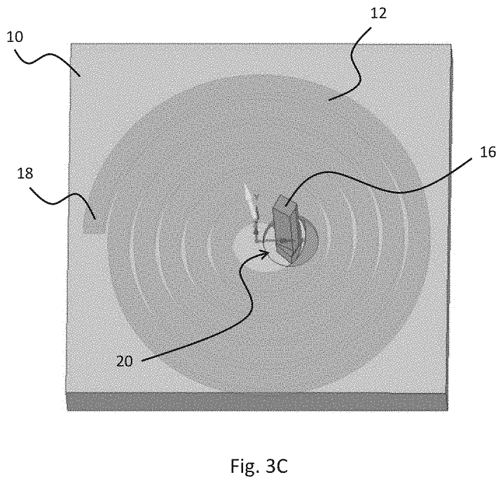

Support removal structure 12 is shown in greater detail in FIGS. 3A-3C. To provide additional support to printed object 10, support removal structure 12 may be arranged in a pattern with the interior of printed object 10, such as the weaved pattern shown in FIG. 3A and the coiled pattern shown in FIGS. 3B-3C. Support removal structure 12 is formed of one or more materials, such that support removal structure 12 has a high tensile strength about a length of support removal structure 12 (with the same principle applied to support removal structure 14 and any other support removal structures employed within printed object 10). Moreover, support removal structure 12 is elongated, resembling a cord, such that support removal structure 12 can be removed from printed object 10 without breaking. As such, since support removal structure 12 includes at least two adjoined portions, as discussed above, the overall elongated nature of support removal structure 12 is such that connections between adjoined portions are not severed during removal. While having a high associated tensile strength, support removal structure 12 is also flexible, such that support removal structure 12 can bend without breaking during extraction from printed object 10. Accordingly, support removal structure 12 may be described as an elongated, compliant length of material that is extractable from printed object 10.

As such, FIGS. 3A-3C show that support removal structure 12 includes first end 16 opposite second end 18, with a length of support removal structure 12 spanning from first end 16 to second end 18. As shown in FIGS. 3A-3C, support removal structure 12 is elongated from first end 16 to second end 18, such that support removal structure 12 can be easily removed from within printed object 10, as will be shown in later figures and discussed in greater detail below.

FIG. 3C in particular shows a method of removing support removal structure 12 from printed object 10. As shown in FIG. 3C, printed object 10 includes at least one extraction opening 20 disposed therein, with extraction opening 20 being formed (either automatically or manually) within at least one of the plurality of exterior geometries and extending through an adjacent one of the plurality of interior geometries. As such, extraction opening 20 provides access to a cavity disposed within and defined by printed object 10. After a procedure to print printed object 10 is complete, it may be desirable to remove support removal structure 12 from within printed object 10, since the main functionality of support removal structure 12 terminates after printed object 10 is formed and dried. Accordingly, support removal structure 12 is extractable from printed object 10 via extraction opening 20, such as by a user or a machine exerting a pulling force on first end 16 of support removal structure 12. As such, the entirety of support removal structure 12 can be removed from printed object 10 via extraction opening 20. It is appreciated that either first end 16 or second end 18 of support removal structure 12 can receive a pulling force to be removed from printed object 10; similarly, while FIG. 3C shows a singular extraction opening 20, it is appreciated that multiple extraction openings may be formed within printed object, depending on the shape, length, and location of support removal structure 12 disposed therein.

Moreover, the shape, design, and length of support removal structure 12 is selected to avoid tangling of support removal structure 12 during extraction; as shown in FIG. 3C, a coiled design provides a path for the length of support removal structure 12 to be removed without tangling. However, it is appreciated that other shapes and designs are contemplated, such as the weaved pattern shown in FIG. 3A, and any other pattern that reduces the likelihood of tangling of support removal structure 12 during printing or extraction.

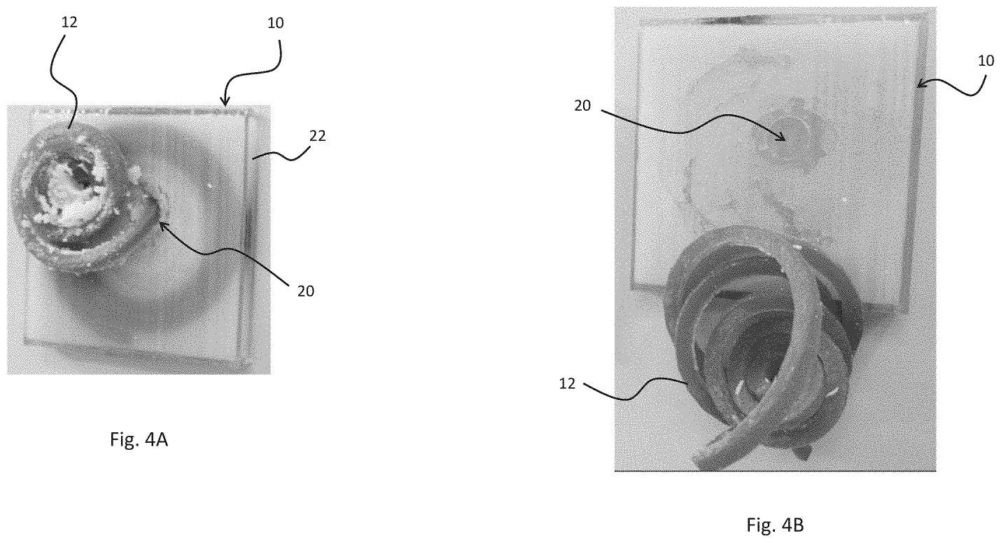

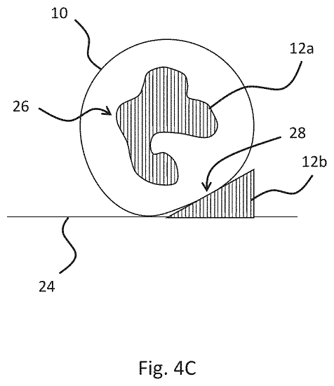

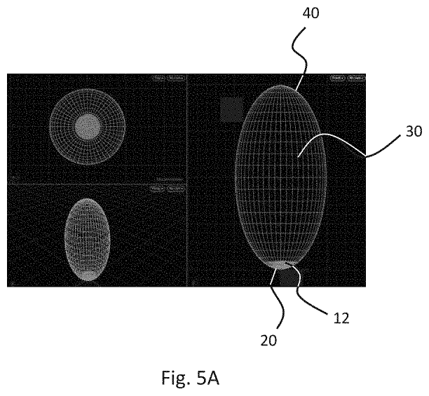

FIGS. 4A-4B depict examples of support removal structure 12 being removed from printed object 10. As shown in FIGS. 4A-4B, printed object 10 includes a plurality of exterior geometries, denoted as reference numeral 22 in FIG. 4A, with an adjacent plurality of interior geometries. A cavity is defined by the plurality of interior geometries of printed object 10, with support removal structure 12 being disposed within the cavity during the manufacture of printed object 10. An extraction opening 20 is formed within at least one of the plurality of exterior geometries and at least one of the plurality of interior geometries, with extraction opening 20 providing access to the cavity and the support removal structure 12 within printed object 10. As noted above, more than one extraction opening 20 may be formed within printed object 10. FIG. 4A depicts a partial removal of support removal structure 12 via extraction opening 20, and FIG. 4B depicts a complete removal of support removal structure 12 from printed object 10. After the removal of support removal structure 12 from printed object 10, the cavity may be filled with material to provide a solid body for printed object 10.

In addition, FIG. 4C depicts an embodiment of printed object 10 being manufactured on surface 24. Printed object 10 includes internal feature 26 and external feature 28. To properly support each of internal feature 26 and external feature 28, printed object 10 includes internal support removal structure 12a and external support removal structure 12b, respectively. As such, support removal structure 12 can be either an external support, and internal support, or a combination of external and internal supports, which are removable as described herein.

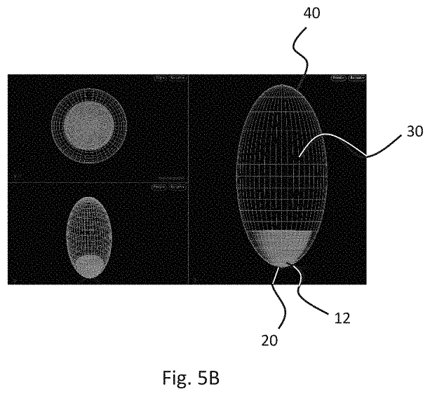

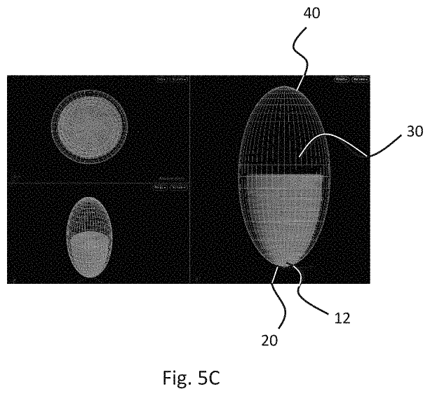

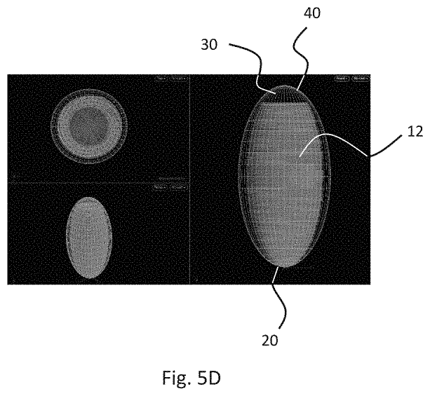

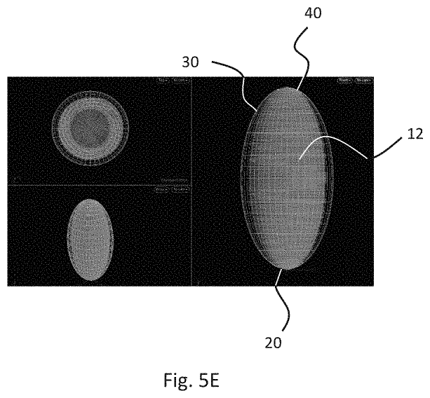

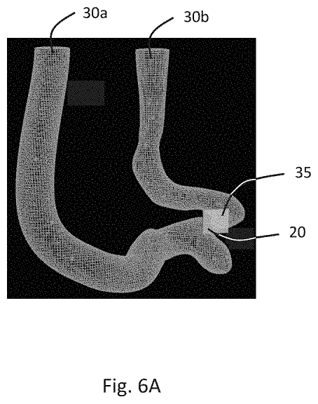

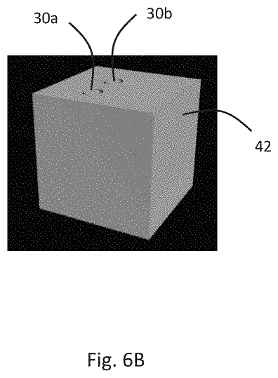

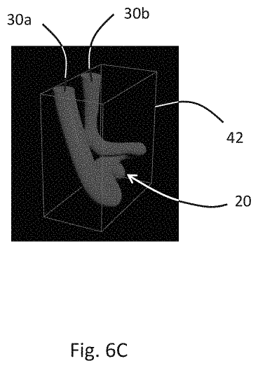

FIGS. 5A-5E and 6A-6C depict examples of calculating an amount and location of support removal structure 12 disposed within printed object 10, as well as one or more extraction openings 20 disposed within printed object 10. To perform the calculations, a support removal structure generator program is used to render a virtual representation of printed object 10. As shown in FIGS. 5A-5E and 6A-6C, the virtual representation includes one or more geometries 40 that form the boundaries of cavity 30 to be filled with an amount of support removal structure 12. Also shown in FIGS. 5A-5E and 6A-6C is that one or more extraction openings 20 are formed within geometries 40, with the extraction openings 20 also being calculated.

The algorithm used to calculate the amount and the shape of the support removal structure 12 begins by selecting a location for extraction opening 20, which may be user-selected or may be automatically selected. The software of the generator program calculates an Archimedean spiral of support removal structure 12 that expands until reaching an edge of geometry 40, ensuring that no knots or kinks form in the spiral. Support removal structure 12 has an associated height and thickness that may be user-defined or automatically defined by the software. Upon reaching the edge of geometry 40, the software calculates another spiral from the edge of geometry 40, expanding inward to a point disposed between the edges of geometry 40 and above extraction opening 20. The algorithm proceeds by calculating spirals within geometry 40 until the volume defined by cavity 30 fills with a singular length of support removal structure 12.

As shown in FIGS. 6A-6C in particular, multiple geometries defining different cavities may be calculated, in which support removal structure is disposed during printing. For example, first cavity 30a and second cavity 30b, each defined by a separate geometry, may be calculated by the generator program, with break point 35 disposed between first cavity 30a and second cavity 30b. Extraction opening 20 may be located adjacent to break point 35, such that support removal structure 12 from each of first cavity 30a and second cavity 30b can be removed via a singular extraction opening 20.

To create the support structure for the printed object formed from the cavities shown in FIGS. 6A-6C, bounding box 42 is created that completely contains the virtual representation of the printable structure within the generator program. Next, Signed Distance Field (SDF) volumes are created of both the structure itself and of bounding box 42. An SDF volume is an array of float values that defines the surface of a structure, as well as the distance between the surface each discreet point of the object. The surface volumes are then subtracted to create a volume that contains the interior of printable object 10, which is separated from the rest of the volume of bounding box 42. The interior structure is then isolated from the rest of the bounding volume and serves as the base of the removable support object. After that, support removal structure 12 can then be optionally separated at break point 35, such may be user-defined or automatically defined, to create multiple separate removable support structures within first cavity 30a and within second cavity 30b.

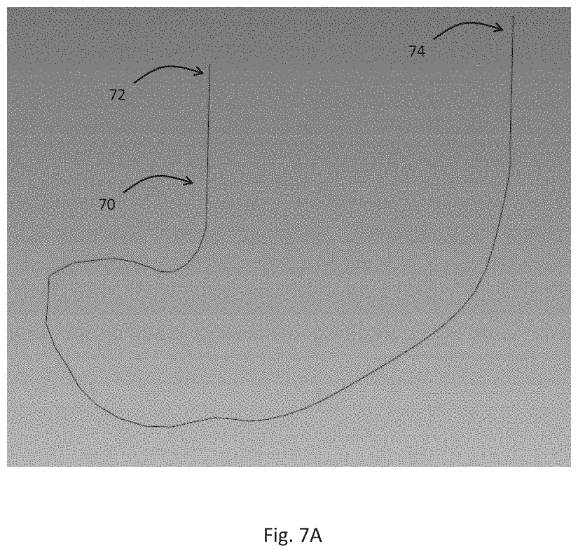

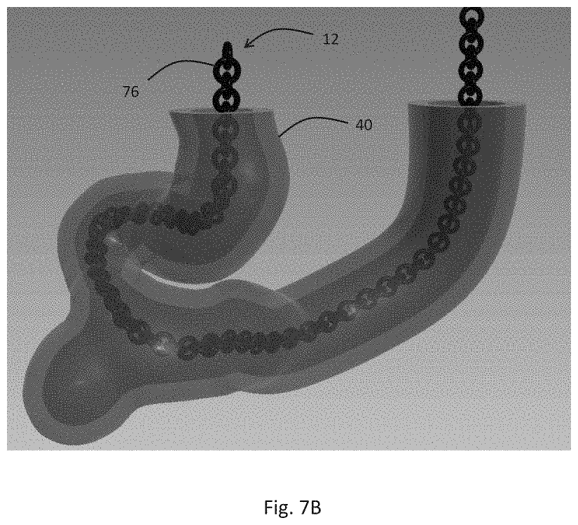

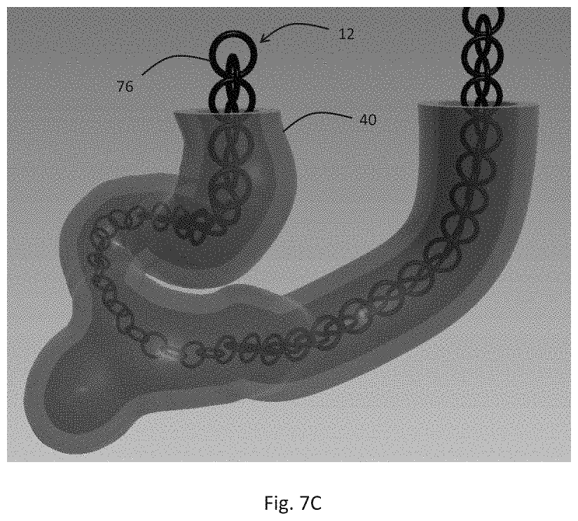

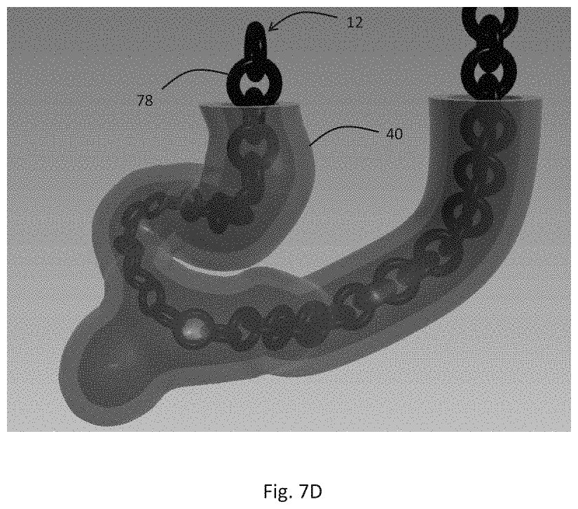

FIGS. 7A-7D depict a method of generating support removal structure 12. As shown in FIG. 7A, a pathfinding algorithm is used to generate a path 70 from a first end 72 to a second end 74 of a virtual model that represents printed object 10. Path 70 is generated by removing the volume of the virtual model without losing continuity, followed by executing instructions to generate a space colonization algorithm along path 70 to obtain the average centerline throughout the model. FIGS. 7B-7C depict the propagation of uniform links 76 about path 70, with each link 76 being identical in shape and size, and each subsequent link 76 rotated 90° with respect to the previous link. As such, the links 76 interlock about the curve of path 70. The curve of path 70 is then resampled so that each discreet point on path 70 is equidistant from each other, at a distance that equals the length of the whole link 76 minus two times the thickness of the link plus a modifier to allow for tolerance. Finally, the links 76 are applied at each point along the curve of path 70, alternating between the rotated and unrotated versions of the links 76 to create interlocked chain links along the length of the mesh (also referred to as path 70). Geometry 40 is then propagated about links 76 on path 70 to generate a final geometry 40 to be printed including links 76 as uniform removable support structures therein.

As shown in FIG. 7D, non-uniform segments 78 can also be used to generate support removal structure 12. Since the size of each link 78 is not known at the start of the simulation, the resampling step is more complicated. A pscale randomized scale attribute is added to each point on the curve of path 70 and is used to determine a uniform scale for each link 78. The curve also needs to be resampled, but the tolerance value described above in relations to FIG. 7B is used as a modifier that shrinks the linkages closer together. It is necessary to find a value that will be small enough that the smaller linkages will connect without interpenetrating between each other, and large enough that the larger linkages do not clip at the center of the links 78. As such, it is better to have small size fluctuations, or alternatively, thin links that have more space between them. After the resampling, and the pscale randomized scale attributes are determined, and the links 78 are distributed along the curve making another chain, now of varying thicknesses. The non-uniform segments or links 78 thereby allow for better reduction of support material as the volumes are more filled.

The advantages set forth above, and those made apparent from the foregoing description, are efficiently attained. Since certain changes may be made in the above construction without departing from the scope of the invention, it is intended that all matters contained in the foregoing description or shown in the accompanying drawings shall be interpreted as illustrative and not in a limiting sense.

It is also to be understood that the following claims are intended to cover all of the generic and specific features of the invention herein described, and all statements of the scope of the invention that, as a matter of language, might be said to fall therebetween.

What is claimed is:

1. A method of designing and printing structures for the purpose of removing a support structure from an additive manufactured object, the method comprising the steps of:
generating a virtual model representation of an object, the virtual model including a plurality of geometries including exterior geometries opposite interior geometries, such that the interior geometries at least partially define a cavity disposed within the virtual model;
identifying one or more of the plurality of geometries to be supported via a support removal structure during fabrication;
calculating an amount of the support removal structure to support at least one of the plurality of geometries, the support removal structure having an overall shape and dimensions calculated based on the identified one or more of the plurality of geometries and arranged to support the identified one or more of the plurality of geometries, the support removal structure including at least two adjoined portions;
fabricating a printed object based on the virtual model, the printed object including the identified one or more of the plurality of geometries and the calculated amount of the support removal structure; and
via an extraction opening disposed within at least one of the plurality of geometries, removing at least a portion of the amount of the support removal structure from the printed object, wherein the extraction opening provides a channel to the cavity, and wherein each of the at least two adjoined portions are at least partially removed via the extraction opening without severing a connection between the at least two adjoined portions.

2. The method of claim 1, further comprising a step of filling a space between the support removal structure and the one or more of the plurality of geometries with a support material.

3. The method of claim 2, further comprising a step of removing the support material via the extraction opening after the step of fabricating the printed object based on the virtual model.

4. The method of claim 1, further comprising a step of forming the extraction opening before the step of fabricating the printed object based on the virtual model, such that the printed object includes the extraction opening.

5. The method of claim 1, wherein the support removal structure is a first support removal structure, further comprising a step of calculating an amount of a second support removal structure having an overall shape and dimensions calculated based on the identified one or more of the plurality of geometries and arranged to support the identified one or more of the plurality of geometries.

6. The method of claim 5, further comprising a step of removing at least a portion of the second support removal structure via the extraction opening after the step of fabricating the printed object based on the virtual model.

7. The method of claim 1, wherein the extraction opening is a first extraction opening, further comprising a step of removing at least a portion of the amount of the support removal structure from the printed object via a second extraction opening.

8. The method of claim 1, wherein the step of calculating the amount of the support removal structure further comprises:
calculating a path from a first end of the virtual model to a second end of the virtual model;
propagating a plurality of linked bodies about the path; and
rotating each subsequent body of the plurality of linked bodies to join the plurality of linked bodies together, thereby forming the support removal structure.

9. The method of claim 8, wherein the plurality of linked bodies are uniform in size and shape.

10. The method of claim 8, wherein the plurality of linked bodies are non-uniform in size and shape.

11. A method of designing and printing structures for the purpose of removing a support structure from an additive manufactured object, the method comprising the steps of:
generating a virtual model representation of an object, the virtual model including a plurality of exterior geometries defining a shape of the object and a plurality of interior geometries disposed opposite the plurality of exterior geometries, the plurality of interior geometries at least partially defining a cavity disposed within the virtual model;
identifying one of the plurality of interior geometries to be supported via a support removal structure and a support material during fabrication;
calculating an amount of a support removal structure disposed within the cavity of the virtual model to support the identified one or more of the plurality of interior geometries by:
calculating a path from a first end of the virtual model to a second end of the virtual model;
propagating a plurality of linked bodies about the path; and
rotating each subsequent body of the plurality of linked bodies to join the plurality of linked bodies together, thereby forming the amount of the support removal structure; and
fabricating a printed object based on the virtual model, the printed object including the plurality of exterior geometries, the plurality of interior geometries, the cavity, and the calculated amount of the support removal structure arranged within the cavity in the calculated overall shape and dimensions,
wherein the calculated support removal structure includes an overall shape and dimensions based on the identified one of the plurality of interior geometries and is arranged to support the identified one of the plurality of interior geometries.

12. The method of claim 11, further comprising a step of removing at least a portion of the support removal structure from the printed object via an extraction opening disposed within at least one of the plurality of exterior geometries and at least one of the plurality of interior geometries, wherein the extraction opening provides a channel to the cavity.

13. The method of claim 12, further comprising a step of forming the extraction opening before the step of fabricating the printed object based on the virtual model, such that the printed object includes the extraction opening.

14. The method of claim 12, further comprising a step of filling a space between the support removal structure and the plurality of interior geometries with the support material.

15. The method of claim 14, further comprising a step of removing the support material via the extraction opening after the step of manufacturing the printed object based on the virtual model.

16. The method of claim 11, wherein the support removal structure is a first support removal structure, further comprising a step of calculating an amount of a second support removal structure disposed within the cavity of the virtual model.

17. The method of claim 16, further comprising a step of removing at least a portion of each of the first and second support removal structures via an extraction opening disposed within at least one of the plurality of exterior geometries and at least one of the plurality of interior geometries, wherein the extraction opening provides a channel to the cavity.

18. A method of designing and printing structures for the purpose of removing a support structure from an additive manufactured object, the method comprising the steps of:
generating a virtual model representation of an object, the virtual model including a plurality of exterior geometries defining a shape of the object;
identifying a plurality of interior geometries disposed opposite the plurality of exterior geometries, the plurality of interior geometries at least partially defining a cavity disposed within the virtual model;
calculating an amount of a first support removal structure and an amount of a second support removal structure to be disposed within the cavity of the virtual model, each of the first and second support removal structures having an overall shape and dimensions calculated based on the identified plurality of interior geometries, and each of the first and second support removal structures including at least two adjoined portions;
forming at least one extraction opening disposed within at least one of the plurality of exterior geometries and at least one of the plurality of interior geometries, the at least one extraction opening providing a channel to the cavity;
fabricating a printed object based on the virtual model, the printed object including the plurality of exterior geometries, the plurality of interior geometries, the at least one extraction opening, the cavity, and the first and second support removal structures arranged within the cavity in the calculated overall shape and dimensions; and
via the at least one extraction opening, removing at least a portion of each of the first and second support removal structures from the printed object, wherein, for each of the first and second support removal structures, each of the at least two adjoined portions are at least partially removed via the extraction opening without severing a connection between the at least two adjoined portions.

19. The method of claim 18, wherein the step of calculating at least the amount of the first support removal structure further comprises:
calculating a path from a first end of the virtual model to a second end of the virtual model;
propagating a plurality of linked bodies about the path; and
rotating each subsequent body of the plurality of linked bodies to join the plurality of linked bodies together, thereby forming at least the amount of the first support removal structure.

20. The method of claim 18, further comprising a step of filling a space between the first and second support removal structures and the plurality of interior geometries with a support material.
